(19) United States
(12) Patent Application Publication
(10) Pub. No.: US 2008/0060922 A1
(43) Pub. Date: Mar. 13, 2008

(54) Modularized push button switch

(76) Inventor: Benson Su, Sijhiih City (TW)

Correspondence Address: BRUCE H. TROXELL, SUITE 1404, 5205 LEESBURG PIKE, FALLS CHURCH, VA, 22041, US

(21) Appl. No.: 11/518,416

(22) Filed: Sep. 11, 2006

(51) Int. Cl. H01H 13/00

(52) U.S. Cl. 200/329

(57) ABSTRACT

A modularized push button switch of which a main body has a plurality of exposed metallic pins in a front and a rear line, each of the pins is connected with a signal line; a unitary insertion connecting module is provided on a connecting end of the signal lines, the unitary insertion connecting module has inserting holes respectively facing to the metallic pins in the front and the rear lines. Thereby an improved modularized push button switch is formed that has the advantages of effectively preventing the metallic pins from damage, rendering accurate of wire connecting and resulting better quality of the push button switch, and having firmer as well as more reliable structure after insertion assembling.

### BACKGROUND OF THE INVENTION

1. Field of the Invention

The present invention is related to a modularized push button switch for wire connecting, and especially to a modularized push button switch with which metallic pins of a main body of the push button switch can be assembled faster and firmer with related signal lines in a unitary modular mode, this can further elevate the quality of the products obtained by assembling of the main body of push button switch with the related signal lines.

2. Description of the Prior Art

Generally, a push button switch is used as a controller for turning on/off electric power; it has a main body and signal lines connecting with an end of the main body. Basically, the main body of the push button switch has a relieved push button and a micro switch provided in the main body. When the push button is pressed down, a relieved point on the micro switch can be touched and pressed by transmitting of an interior transmitting structure; by controlling electrically, the signal lines of metallic pins connected on the bottom of the micro switch can generate a controlling signal. A push button switch now available, for instance—one used on a game machine, is no more limited to controlling the two signals for turning on and turning off; it must fast transmit a large amount of data signals, this makes complicated of the internal structure, and the amount of related signal lines required for connecting is relatively increased.

FIG. 1 shows one of these conventional push button switches as an example; the main body 10 of the push button switch is provided on its top end with a push button 101, and is provided therein with the micro switch 102; the end of the main body 10 of the push button switch is provided with a plurality of exposed metallic pins 11, 12 in a front and a rear line, for instance, the pins 12 are exactly metallic pins of the micro switch 102; each of the pins 11, 12 needs to be connected with a metallic sheet end 13 (14) of a signal line 15 (16).

In the structure of the main body 10 of the push button switch as stated above, during the assembling process in a factory, each of a front line and a rear line with the metallic pins 11, 12 needs to be checked for its correspondence with the signal lines 15, 16; this not only wastes time, but also is subjected to resulting errors. And by the fact that the exposed front and the rear metallic pins 11, 12 are made from unsupported metal slices, they often are broken or even make shorting out of circuit during assembling to leave the manufacturing factory quite a large trouble.

In view of this, in another structure of a main body 17 of push button switch as shown in FIG. 2, signal lines are provided on their pins in a front line with a covering connecting socket 18 and on their pins in a rear line with a covering connecting socket 19. Thereby the defect of the above stated push button switch can be gotten rid of, yet there are a defect of having the necessity of plural inserting connecting processes and a defect of having no adequate firmness of the assembled structure.

Further, in normal connectors for communication equipment, wire connecting was modularized very long time ago, such as are the cases of the prior art U.S. Pat. Nos. 6,817,884 and 3,569,909; however, modularization of wire connecting of these cases is formed by many signal connections, this is unable applied directly to wire connecting of push button switches.

### SUMMARY OF THE INVENTION

The primary object of the present invention is to provide a modularized push button switch with which metallic pins of a main body of the push button switch can be assembled faster and firmer with related signal lines in a unitary modular mode.

Another object of the present invention is to provide a modularized push button switch; the push button switch can be more accurately connected with the related signal lines to further elevate the quality of the products obtained by assembling of the push button switch with the related signal lines.

To obtain the objects, and end of the main body of the push button switch of the present invention is provided with a plurality of exposed metallic pins in a front and a rear line, each of the pins needs to be connected with a signal line; a unitary insertion connecting module is provided on a connecting end of the signal lines, the unitary insertion connecting module is provided with inserting holes respectively facing to the abovementioned metallic pins in the front and the rear lines.

In a more preferred embodiment, the unitary insertion connecting module and the main body of the push button switch further are provided with a couple of engaging means for engaging with each other.

In a practicable embodiment, the engaging means includes an engaging hook integrally provided on and extending upwards from the end of the insertion connecting module, and an engaging protrusion is provided on a wall of the push button switch in opposition to the engaging hook.

The present invention will be apparent in its novelty and features after reading the detailed description of the preferred embodiment thereof in reference to the accompanying drawings.

### BRIEF DESCRIPTION OF THE DRAWINGS

FIG. 1 is a perspective view showing a conventional push button switch and its related conductors;

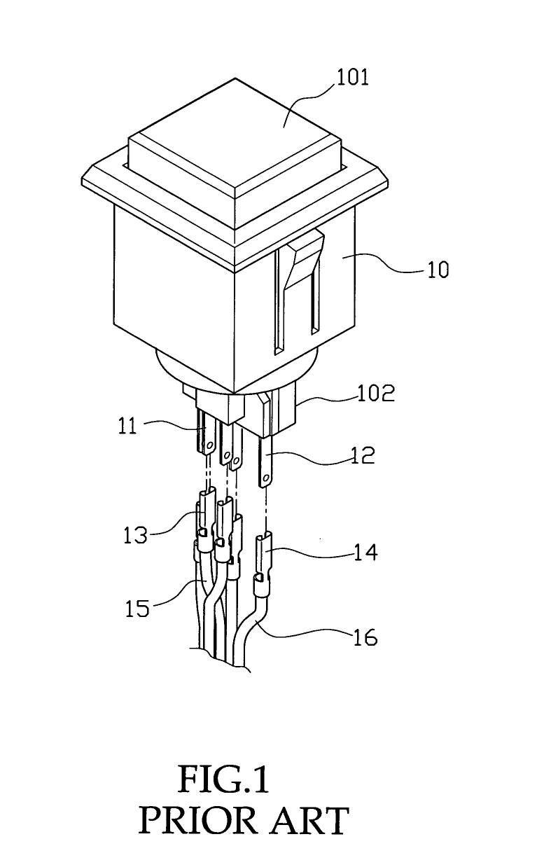

FIG. 2 is a perspective view showing another conventional push button switch and its related conductors;

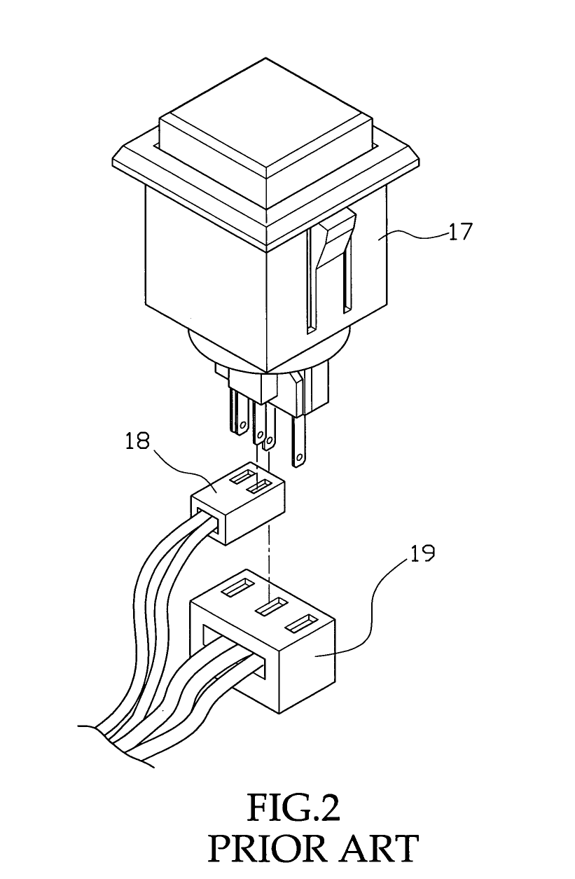

FIG. 3 is a perspective view showing a preferred embodiment of the present invention;

FIG. 4 is a front view taken from FIG. 3 after assembling.

### DETAILED DESCRIPTION OF THE PREFERRED EMBODIMENT

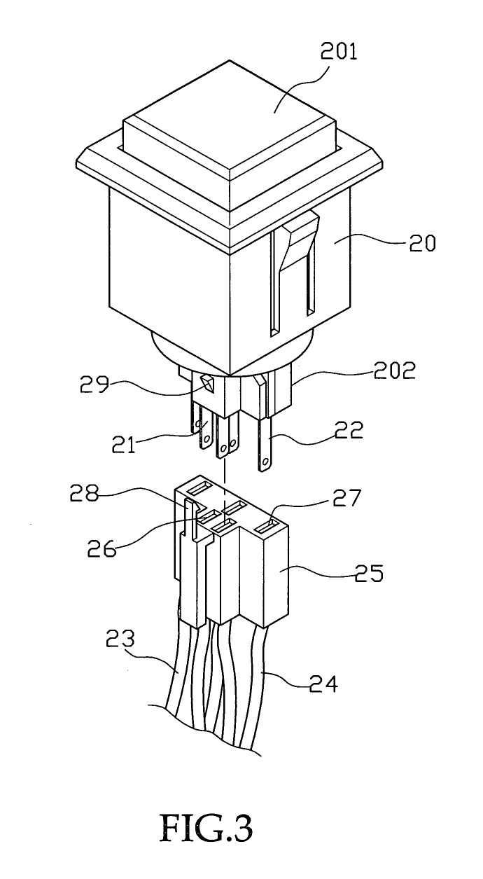

Referring to FIG. 3, in the embodiment depicted, a main body 20 of a push button switch is provided on its top end with a push button 201, and is provided therein with the micro switch 202; When the push button 201 is pressed down, a relieved point on the micro switch 202 can be touched and pressed by transmitting of an interior transmitting structure (not shown); by controlling electrically, signal lines 23, 24 of a plurality of metallic pins 21, 22 in a front and a rear line on the bottom of the micro switch 202 can generate a controlling signal. Wherein the metallic pins 22 in the rear line are three metallic pins for the micro switch 202; while the metallic pins 21 in the front line are two in amount.

The totally five metallic pins 21, 22 in the front and rear lines are exposed and each needs to be connected with one of a plurality of signal lines 23, 24. The feature of the present invention is resided in that: a unitary insertion connecting module 25 is provided on a connecting end of the five signal lines 23, 24. The unitary insertion connecting module 25 is provided with inserting holes 26, 27 respectively facing to the abovementioned metallic pins 21, 22 in the front and the rear lines; the inserting holes 26, 27 amount to five, and each is embedded in an electric conductive tailing end of a corresponding one of the five signal lines 23, 24.

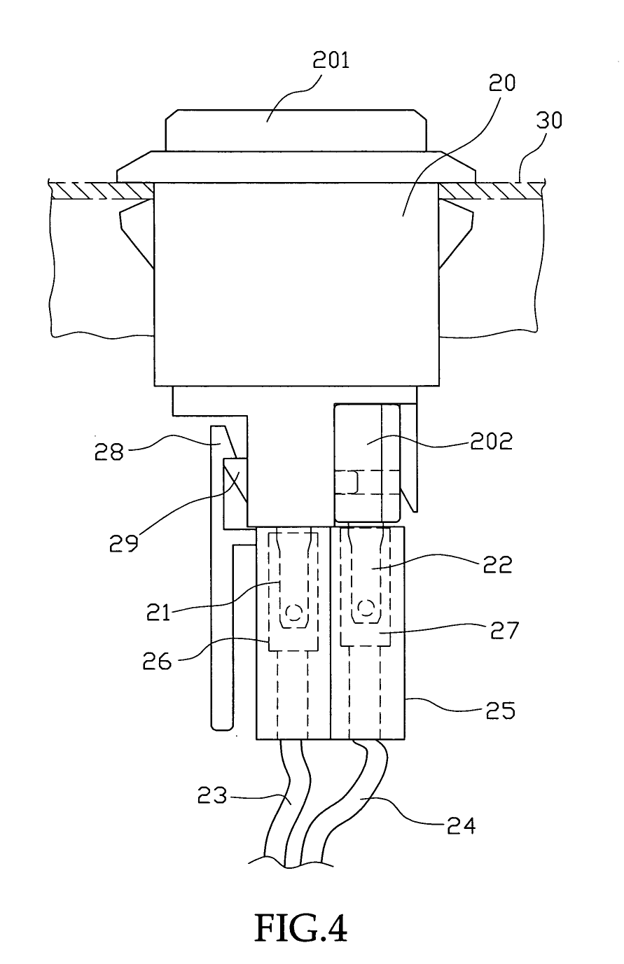

As shown in FIGS. 3, 4, in the preferred embodiment depicted, the main body 20 of the push button is installed on an opening of a panel 30 of a machine. The unitary insertion connecting module 25 and the main body 20 of the push button switch further are provided with a couple of engaging means for engaging with each other; so that the structure after assembling of the unitary insertion connecting module 25 with the main body 20 of the push button switch can be firmer and more reliable. In this embodiment, the engaging means includes an engaging hook 28 integrally provided on and extending upwards from the end of the insertion connecting module 25, and an engaging protrusion 29 is provided on a wall of the push button switch in opposition to the engaging hook 28; so that in insertion connecting of the insertion connecting module 25 with the main body 20 of the push button switch, the engaging hook 28 and the engaging protrusion 29 can be engaged with each other to form a firmly connecting state as is shown in FIG. 4.

Therefore, the push button switch of the present invention can be assembled faster with related signal lines, this not only can prevent the metallic pins from damage, but also has the advantages of rendering accurate of wire connecting and resulting better quality of the push button switch, and having a firmer as well as more reliable structure after insertion assembling, the present invention thus has its industrial value.

The embodiment cited above is only for illustrating a preferred embodiment of the present invention, and not for giving any limitation to the scope of the present invention; it will be apparent to those skilled in this art that various modifications or changes can be made to the elements of the present invention without departing from the spirit and scope of this invention. Accordingly, all such modifications and changes, such as of the above stated engaging means provided on the unitary insertion connecting module and the push button switch for engaging with each other, also fall within the scope of the appended claims.

1. A modularized push button switch for wire connecting, said push button switch comprises:
a main body having on its top end a push button and being provided therein with the micro switch, when said push button is pressed down, said micro switch is touched and pressed to output a signal, a plurality of exposed metallic pins in a front and a rear line are provided on an end of said main body of said push button switch;
a plurality of signal lines each having an electric conductive tailing end in electric connection with a corresponding one of said metallic pins; and
a unitary insertion connecting module provided on a connecting end of said signal lines, said unitary insertion connecting module is provided with inserting holes respectively facing to said metallic pins in said front and said rear lines;
said inserting holes each is embedded in one of said electric conductive tailing ends of a corresponding one of said signal lines;
when in connecting said unitary insertion connecting module with said main body of said push button switch, each of said inserting holes is inserted therein with a corresponding one of said metallic pins in said front and said rear lines, in order that each of said metallic pins is electrically connected with a corresponding one of said signal lines.

2. The modularized push button switch for wire connecting as claimed in claim 1, wherein said unitary insertion connecting module and said main body of said push button switch further are provided with a couple of engaging means for engaging with each other.

3. The modularized push button switch for wire connecting as claimed in claim 2, wherein said engaging means includes an engaging hook integrally provided on and extending upwards from an end of said insertion connecting module, and an engaging protrusion is provided on a wall of said push button switch in opposition to said engaging hook.

4. The modularized push button switch for wire connecting as claimed in claim 1, wherein said metallic pins in said front and said rear lines amount to five, and said unitary insertion connecting module correspondingly has five inserting holes.

5. The modularized push button switch for wire connecting as claimed in claim 4, wherein said metallic pins in said rear line amount to three, while said metallic pins in said front line amount to two.

6. The modularized push button switch for wire connecting as claimed in claim 1, wherein said main body of said push button is installed on an opening of a panel of a machine.
